(19) United States
(12) Patent Application Publication
(10) Pub. No.: US 2022/0202187 A1
(43) Pub. Date: Jun. 30, 2022

(54) Brazilian Butt Lift adjustable chair/bed with hole in seating area

(71) Applicant: Viridiana Rangel, Spring, TX (US)

(72) Inventor: Viridiana Rangel, Spring, TX (US)

(21) Appl. No.: 17/512,283

(22) Filed: Oct. 27, 2021

Related U.S. Application Data
(63) Continuation of application No. 63/108,583, filed on Nov. 2, 2020.

(51) Int. Cl. A47C 7/02; A47C 1/02; A47C 1/14; A47C 4/28

(52) U.S. Cl. CPC A47C 7/029; A47C 1/02; A47C 7/0213; A47C 4/28; A47C 1/14

(57) ABSTRACT

An adjustable chair that converts into a bed with a hole in the center of the chair's seating area and ⅔ down when converted into a bed. The purpose of the hole is so that no pressure is applied to the gluteal are when sitting down or when lying down. This is essential after an operation on the gluteal area. The chair is a folding frame with cloth arranged on the frame and is also composed of a tripod. It also has an armrest to allow more comfort to user.

### TECHNOLOGY

The utility model relates to a chair that converts into a bed with a hole in the cloth of the chair/bed which, is utilized for medical reasons such as Brazilian butt lift, hemorrhoids surgery, and any type of gluteal surgery.

### BACKGROUND TECHNOLOGY

The existing adjustable chair to bed is widely available and it can be used for user to rest when expanded and sitting down. However, the existing folding chair is only used for the basic function of the chair and same for the bed, but because the chair/bed does not have a hole in the center of the sitting area and ⅔ down when converted into bed it makes it very uncomfortable for user when sitting or laying down.

Utility Model

The purpose of the Brazilian butt adjustable chair that converts into a bed main advantage is that it allows no pressure on the gluteal area in the case where the gluteal is sensitive to the touch or no pressure should be applied to the gluteal for a period.

The technical scheme for the realization of the utility model is as follows

The Brazilian butt lift adjustable chair that converts into a bed is mainly composed of a folding frame and a cloth arranged on the folding frame. The folding frame is composed of a face frame and a bracket hinged on the face frame, and a support frame is also arranged on the face frame. There is a hole in the cloth so that when set up as a chair the hole is centered in the sitting area and once converted into a bed the hole is located ⅔ towards the bottom of the bed so that when laying down the gluteal area will fit in the hole so that it will have no pressure applied to the gluteal.

The face frame is composed of a tripod, a seat frame hinged on the tripod, and a support frame hinged on the seat frame. The supporting frame is hinged on the backing frame. As an optional connection method, the support frame is hinged with the back frame through a connecting piece.

Furthermore, the bracket consists of a first base frame hinged to one end of the base frame, a second base frame hinged to the other end of the base frame, a connecting rod connecting the second base frame and the foot frame and connecting the second base frame and the backrest. The support rod of the frame and the connecting frame connecting the first base frame and the back frame and formed. In order to make it more comfortable when sitting down and resting, the armrest is provided with an armrest.

As an optimal arrangement, the hinged end of the seat frame and the back frame is arc-shaped, and the connecting frame is formed by a support rod hinged on the back frame and a fixed structure connecting the support rod and the first chassis.

Compared with the prior art, the utility model has the following beneficial effects:
1. The arrangement of the hole in the cloth of the present invention enables the support of the present invention to avoid the problem of applying pressure when sitting or lying down and greatly meet the needs of users.

Below are the figures where the drawing marks correspond to the component name:

1—cloth, 2—support frame, 3—scaffolding, 4—seater, 5—frame, 6—first base frame, 7—second base frame, 8—connecting rod, 9—rail, 10—support rod, 11—fixed frame, 12—connecting piece, 13—hole in cloth.

### DESCRIPTION OF FIGURES

Drawing 1 shows the overall structure of the utility model.

Drawing 2 shows the unfolded structure of the utility model.

Below are the figures where the drawing marks correspond to the component name:

1—cloth, 2—support frame, 3—scaffolding, 4—seater, 5—frame, 6—first base frame, 7—second base frame, 8—connecting rod, 9—rail, 10—support rod, 11—fixed frame, 12—connecting piece, 13—hole in cloth.

### THE EMBODIMENT

As shown in drawing 1, the utility model consists mainly of a folding frame and a cloth 1 arranged on the folding frame with a hole 13 in cloth, and the folding frame is composed of a face frame and a bracket hinged on the face frame, and a support frame 2 is also provided on the face frame.

The face frame consists of scaffold 3, seat frame 4 articulated on scaffold 3 and ad frame 5 that is articulated on stand 4. the support frame 2 is articulated on the frame 5 by the connector 12. the connector 12 is equipped with a snap tooth, which can be set to better connect the support frame 2 to the frame 5. when expanding, the relaxation between support frame 2 and frame 5 is avoided, affecting the rest quality.

The bracket consists of a first base frame 6 articulated at the 4th end of the holder, a second base frame 7 at the other end of the seat frame 4, a connecting rod 8 connecting the second base frame 7 to the scaffold 3, a support rod 9 connecting the second base frame 7 and a frame 5, and a connection structure connecting the first base frame 6 to the frame 5. the end of the bracket 4 and the frame 5 are articulated in an arc, and the connecting frame consists of a support rod 10 hinged on the frame 5 and a fixed frame 11 connecting the support rod 10 and the first base frame 6.

The above scaffolding 3, seat frame 4, frame 5, first base frame 6 and the second base frame 7 are U-shaped structure, scaffolding 3 opening end and seat 4 opening end articulation, frame 5 and the first base frame 6 opening end are hinged with the seal end of the seat 4, the second base frame 7 opening end through the rod 9 and frame 5 hinge.

In order to make the user more comfortable and practical when using, the armrest 9 is provided with armrests and the cushions with removable connections are provided on the frame 5.

In addition to comfort a hole 13 is created in cloth 1 centered when sitting and ⅔ down when lying down to avoid pressure on the gluteal area.

When the folding recliner of the utility model needs to be closed, it is necessary to close the scaffold 3, seat frame 4 and frame 5 in the shape of “Z”, and then close the first base frame 6 to the scaffold 3 and the seat 4, and then put away the folding recliner.

When the folding recliner of the utility model needs to be expanded, the change between the chair and the bed can be realized by simply adjusting the position of the connecting frame.

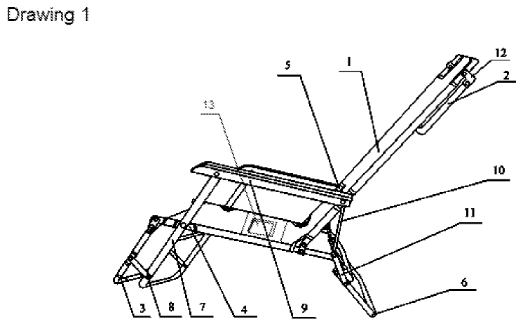

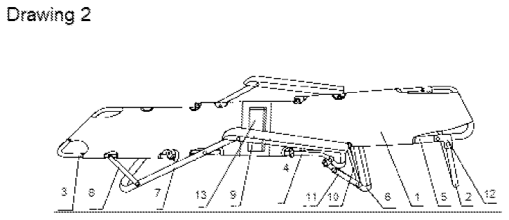

For the folding recliners shown in drawing 1, simply pull the hinges of the holder 11 and support lever 10 out away from the seat frame 4 and lower the frame 5 so that it is on the same level as the seat frame 4. since the second base frame 7 and the frame 5 are hinged on the lever 9, the second base frame 7 is hinged with the seat frame 4, the scaffold 3 is articulated by the connecting rod 8 and the second base frame 7, so at this time the scaffold 3, the seat 4 and the frame 5 are all on the same horizontal surface, as shown in FIG. 3. pull out the support frame 2, support frame 2 and frame 5 between the formation of an angle greater than 90 degrees, at this time, you can effectively achieve the supporting role of support frame 2, to avoid the situation of frame 5 fall. according to the above description, the expansion of the folding deckchair of the utility model can be realized. according to the above design, the utility model can be better realized.

1. deck chair, composed of a folding frame and a cloth (1) with a hole on the seat area (13) disposed on the folding rack, the folding frame is composed of a face frame and a bracket hinged on the face rack, which is characterized in that: the face frame is also provided with a support frame (2).

2. the deck chair according to claim 1, wherein: said face frame by a tripod (3), hinged to the tripod (3) and hinged to the seat frame (4) on the frame (5) composition; said support frame (2) hinged to the frame (5)

3. the deck chair according to claim 2, wherein: said support frame (2) is articulated by means of a connector (12) and a frame (5)

4. the deck chair according to claim 3, wherein: said bracket is hinged to the first base frame (6) at one end of the seat frame (4), hinged to the second base frame (7) at the other end, connecting the second base frame (7) and the tripod (3) of the connecting rod (8), connecting the second base frame (7) and the supporting frame (5) of the helper (9) and connecting the first base frame (6) and the supporting frame (5) of the connection structure

5. the deck chair according to claim 4, wherein: said armrest (9) is provided with armrests

6. the deck chair according to claim 4 or claim 5, wherein: said seat frame (4) and the support frame (5) are hinged to one end of the frame (5) is curved, said connecting frame is hinged to the support bar (5) (10) and the connecting support rod (10) and the first base frame (6) of the fixing frame (11) constituted

7. the deck chair according to claim 6, wherein: said backing frame (5) is provided with a detachable connection cushion
